(19) United States
(12) Patent Application Publication
(10) Pub. No.: US 2002/0018327 A1
(43) Pub. Date: Feb. 14, 2002

(54) Multi-winding fault-current limiter coil with flux shaper and cooling for use in an electrical power transmission/distribution application

(76) Inventors: Michael S. Walker, Albany, NY (US); Drew W. Hazelton, Selkirk, NY (US)

Correspondence Address: ROSENMAN & COLIN LLP, 575 MADISON AVENUE, NEW YORK, NY, 10022-2585, US

(21) Appl. No.: 09/902,501

(22) Filed: Jul. 10, 2001

Related U.S. Application Data
(60) Provisional application No. 60/217,113, filed on Jul. 10, 2000.

(51) Int. Cl. H02H 9/00

(52) U.S. Cl. 361/58; 361/19

(57) ABSTRACT

The bridge of a fault current limiter of the bridge type used in an AC power transmission and/or distribution system, has a superconducting coil as a first path and a conventional conductor coil as a second path connected in parallel to the first path. The second path has a substantially higher resistance to DC than the first path, and the superconducting path has a substantially higher impedance to AC than the second path. A DC component of a fault current flows through the superconducting path and an AC component of the fault current flows through the second path. Thermal losses and cooling requirements are reduced.

This application claims the benefit of earlier filed and pending provisional application No. 60/217,113.

### FIELD OF THE INVENTION

This invention is directed to a fault-current limiter device for use in the transmission and distribution of electricity.

### BACKGROUND OF THE INVENTION

In the past three decades, electricity has risen from 25% to 40% of end-use energy consumption in the United States. With this rising demand for power comes an increasingly critical requirement for highly reliable, high quality power. As power demands continue to grow, older urban power systems in particular are being pushed to the limit of performance, and are calling for new solutions. Throughout the electric power industry, from production through transmission and distribution to end use, superconductivity is forming the basis for a new set of technologies that may revolutionize the way the world uses electricity.

Electric power system designers often face fault-current problems when expanding existing buses. Larger transformers result in higher fault-duty levels, allowing higher currents to be drawn in the event of line to line or line to ground faults and forcing the replacement of existing downstream buswork and switchgear not rated for the new fault duty. Alternatively, the existing bus can be broken and served by two or more smaller transformers. Another alternative is use of large, high-impedance transformers, resulting in degraded voltage regulation for all the customers on the bus. The classic tradeoff between fault control, bus capacity, and system stiffness has persisted for decades.

A fault-current limiter is designed to react to and absorb unanticipated power disturbances in the utility grid, preventing loss of power to customers or damage to utility grid equipment. Unlike reactors or high-impedance transformers, fault-current limiters will limit fault currents without adding impedance to the circuit during normal operation. The development of superconducting fault-current limiters is being actively pursued by several utilities and electrical manufacturers around the world.

Fault-current limiters are only now being introduced in industrial or utility power grids. Several types of fault-current limiters are presently being developed by various organizations throughout the world. The first two of these operate using the transition of a superconductor from the superconducting to the resistive-state (when the current through the superconductor exceeds its critical current, I_{C}) to suddenly introduce large resistance into the circuit.

One resistive type of fault-current limiter has the superconductor configured so that it has relatively low inductive impedance. The current in this case is limited directly by the introduction of resistance as the critical current of the superconductor is exceeded. A second resistive type of fault-current limiter relies on this sudden appearance of resistance to force the current through an inductive path, thus limiting the current to a level determined by the inductive reactance. This type of limiter is sometimes referred to as an “inductive” type of limiter. One form of this second type of fault current limiter has the superconductor as the shorted secondary of transformer, with the transformer primary connected in series with the load. As the critical current is exceeded in the superconductor and the superconducting, secondary winding becomes resistive limiting its current, the primary is limited to an equivalent number of ampere-turns. The secondary in-effect shields the core from the magnetic field of the primary, and so this type of fault current limiter has also been called a “shielding” type of fault-current limiter.

For all of these basically resistive types of fault-current limiters, an energy given by the integral of voltage, V, across the superconductor times its current, I, during the period of the fault gives the energy that is converted to heat (joule heating) in the superconductor. V rises to the source level, Vₘₐₓ, and I=V/R drops as the temperature rise in the superconductor causes its effective R to increase. All resistive types of fault current limiters can be beneficially made using high temperature superconductors which at the higher temperatures (typically up to 77K, as compared to low temperature superconductors which are effective only to about 20K) have higher heat capacity and so tend not to rise as rapidly in temperature in response to joule heating during faults, allowing better prospects of resumption of superconducting operation within normal breaker reclose times.

The present invention improves upon a third, bridge type of fault-current limiter, which was invented by Boenig and is described in U.S. Pat. Nos. 4,490,769 and 5,726,848. For this type of limiter the integral of limiter voltage times limiter current describes the energy that is stored in an inductive coil that also serves to limit the current. With proper design the critical current of the superconductor is not exceeded and no substantial heating of the superconductor takes place. FIG. 1 shows the circuit schematic diagram for this bridge type of fault-current limiter.

FIG. 1 shows a schematic diagram of a prior art simplified single-phase circuit for the Boenig bridge type of fault-current limiter for an electrical transmission or distribution application. Typically three such circuits would be utilized, one for each phase in a three phase electric power transmission or distribution system.

AC circuit 100 includes an AC source 105, having a source impedance represented by an inductor 110 that is electrically connected to a load 125. The AC source 105 can be either a generator, a transformer, or a transmission or distribution line from a generator or transformer. The load 125 has an inductance, represented by an inductor 130, and a resistance, represented by a resistor 135, through a current-limiter arrangement, represented by a bridge circuit 115. A circuit breaker 120 is arranged between the bridge circuit 115 and the load 125. Additionally, the bridge circuit 115 is a single-phase bridge fault-current limiter that includes a silicon-controlled rectifier 140, a silicon-controlled rectifier 145, a silicon-controlled rectifier 150, a silicon-controlled rectifier 155, an inductor 165, and a DC current bias supply 170 (externally supplied current).

In one application, the AC source 105 and the source impedance, i.e., the inductor 110, would be the secondary of a step-down transformer (for example, for operation at tens of megawatt levels of power in the 10 KV to 500 KV range) within an electrical transmission/distribution network. In this example, the current limiter of the AC circuit 100, i.e., the bridge circuit 115, with the load 125 is considered that portion of an electrical distribution extending electrically downstream of the generator or main step-down transformer. As such, it should be noted that the load 125 is considered to be representative of a larger distribution network that may include additional loads, transformers, and further protective devices as circuit breakers and relays. A suitable circuit breaker 120 is serially interposed in the AC circuit 100 with the AC source 105 and the load 125.

The current limiter includes a power semiconductor bridge, i.e., the bridge circuit 115, having a suitable power semiconductor device or strings of such devices connected in each of the four legs. The four legs may be considered to include power semiconductor devices, thyristors or the silicon-controlled rectifier 140, 145, 150, and 155, suitable for the voltage, current, and power handling requirements of the particular application. The bridge circuit 115 is connected in series with the AC source 105 and the load 125 by a first connection at one node of the bridge circuit 115 between the silicon-controlled rectifier 140 and the silicon-controlled rectifier 150, and a second connection at an opposing second node between the silicon-controlled rectifier 145 and the silicon-controlled rectifier 155. While each silicon-controlled rectifier 140, 145, 150, and 155 is shown as a single device, it is understood that in actual practice each silicon-controlled rectifier may comprise a series and/or parallel network of silicon-controlled rectifiers.

A suitable current limiting coil, i.e., the inductor 165 and the DC current bias supply 170 are serially connected to nodes of the bridge circuit 115 in parallel with the serially connected silicon-controlled rectifiers 150 and 140, and with the serially connected silicon-controlled rectifiers 145 and 155. Under normal operating conditions the DC current bias 170 drives a current (arrows 172) through the silicon-controlled rectifiers 140, 145, 150, and 155 and back through the inductor 165 at such a value as to exceed the peak acceptable operating current of the AC source 105. In such a normal operating condition, the DC current bias 170 forward biases the silicon-controlled rectifiers 140, 145, 150, and 155 such that the AC current supplied by the AC source 105 can flow to the load 125 with very low impedance.

When a fault (short term transient event) occurs, the fault current rises to a level exceeding the DC bias current, causing the silicon-controlled rectifiers 140 and 155 to block current flow for one half cycle, while the silicon-controlled rectifiers 150 and 145 block current flow for the next half cycle, and so forth, thereby forcing an increasing full-wave rectified pulsed DC current to flow through the large impedance of the inductor 165 and reducing the AC fault current passed through the bridge circuit 115 to a fraction of the short circuit fault current that would otherwise be allowed by the overall transmission/distribution grid system. The fault current is maintained at this reduced level to enable the relays and other circuit breakers “downstream” to perform their function of blocking, locating and allowing the clearing of the fault promptly, without triggering the main circuit breaker 120, which would not only shut off power to a large section of the downstream circuit, but prevent location of the fault for switching and repairs as necessary.

The inductor 165 is typically a large coil that produces a substantial magnetic field. The inductance of the inductor 165 can be adjusted by the number of turns in the coil such that the reactive impedance of the inductor 165 limits the rate of current and magnetic field increase in the inductor 165 and, via the bridge circuit 115, limits the maximum level of current that can be drawn during fault. The inductor 165 can be wound of either copper or aluminum or other conventional conductors, or of superconductors.

However, whether the inductor 165 is made with copper or aluminum conductors or other conventional conductors or with superconductors there are difficulties, as summarized below.

The inductor 165 formed of superconductor material has no resistance and, therefore, no I²R Joule heating losses from the DC current caused by the bias supply 170 in normal operation. The DC current bias 170 can, however, have an appreciable AC ripple component on the current through the inductor 165. Much larger but short-duration AC current components are experienced through the inductor 165 during faults. These AC components can produce eddy current and superconductor hysteresis losses, which tend to heat up the conductor. In order to keep the superconducting inductor 165 cold, i.e., well below its transition temperature where it can carry a substantial superconducting current, these losses must be removed by refrigeration. The associated refrigeration process will require a certain amount of compressor power per Watt of loss depending on the temperature of operation of the superconducting inductor 165. For example, if the inductor 165 is made with high temperature superconductors (HTS), operating near 77 K, the required compressor power is about 20 Watts per Watt of loss. However, if the inductor 165 is made with low temperature superconductors (LTS), operating near 4.2 K, the required compressor power is as high as kilowatts per Watt of loss. This power for the compressors is not available to the electric power user and so is considered a loss and contributes to the inefficiency of the system.

While LTS conductors can be made of relatively ductile materials in a form consisting of transposed fine filaments for relatively low AC losses, the large compressor power required per Watt of loss at low temperatures still makes the required refrigeration power considerable. It is difficult to similarly transpose present-day (oxide) HTS superconductors in this manner, and so refrigeration power and the capital cost for refrigerators is still high despite their higher temperature of operation and relatively lower refrigeration cost per Watt of AC loss generated.

Copper or aluminum windings, for forming the inductor 165, can more easily be constructed of braided or otherwise transposed insulated strands which effectively and evenly carry the current and reduce AC losses but unless the copper or aluminum conductor is made very large in total cross section to reduce resistance, the DC bias current present during normal operation of the limiter can produce large I²R Joule heating losses, thereby reducing efficiency and requiring fans and/or cooling oil and pumps for cooling to near ambient temperatures. Additionally, large conductor cross sections substantially increase the overall weight and cost of the conductor and increase excessively the volume needed for the inductor 165.

### BACKGROUND PATENTS

U.S. Pat. No. 6,081,987, “Method of making fault current limiting superconducting coil,” assigned to American Superconductor Corporation (Westborough, Mass.), describes a superconducting magnetic coil that includes a first superconductor formed of an anisotropic superconducting material for providing a low-loss magnetic field characteristic for magnetic fields parallel to the longitudinal axis of the coil and a second superconductor having a low loss magnetic field characteristic for magnetic fields perpendicular to the longitudinal axis of the coil. The first superconductor has a normal state resistivity characteristic conducive for providing current limiting in the event that the superconducting magnetic coil is subjected to a current fault.

U.S. Pat. No. 5,930,095, “Superconducting current limiting device by introducing the air gap in the magnetic core,” assigned to Back Joo (Seoul, KR) and Min-Seok Joo (Seoul, KR), describes a superconducting current limiting device protecting an electric circuit from a fault current. The device comprises a magnetically saturable core having saturated and non-saturated states and an input coil for electrically coupling the core to the electric circuit, the input coil drawing a current therethrough so that a magnetic flux is generated in the core due to the current. Further, the core includes a main path for drawing the generated magnetic flux and at least two magnetic paths, a first of the magnetic paths drawing a first portion of the magnetic flux, and a second of the magnetic paths drawing a second portion of the magnetic flux and having a damping element for canceling at least a fraction of the second portion of the magnetic flux to thereby prevent the core from getting into the saturated state.

U.S. Pat. No. 5,912,607, “Fault current limiting superconducting coil,” assigned to American Superconductor Corporation (Westborough, Mass.), describes a superconducting magnetic coil that includes a first superconductor formed of an anisotropic superconducting material for providing a low-loss magnetic field characteristic for magnetic fields parallel to the longitudinal axis of the coil and a second superconductor having a low loss magnetic field characteristic for magnetic fields perpendicular to the longitudinal axis of the coil. The first superconductor has a normal state resistivity characteristic conducive for providing current limiting in the event that the superconducting magnetic coil is subjected to a current fault.

U.S. Pat. No. 5,726,848, “Fault current limiter and alternating current circuit breaker,” assigned to The Regents of the University of California (Oakland, Calif.), describes a solid-state circuit breaker and current limiter for a load served by an alternating current source having a source impedance, the solid-state circuit breaker and current limiter comprising a thyristor bridge interposed between the alternating current source and the load, the thyristor bridge having four thyristor legs and four nodes, with a first node connected to the alternating current source, and a second node connected to the load. A coil is connected from a third node to a fourth node, the coil having an impedance of a value calculated to limit the current flowing therethrough to a predetermined value. Control means are connected to the thyristor legs for limiting the alternating current flow to the load under fault conditions to a predetermined level, and for gating the thyristor bridge under fault conditions to quickly reduce alternating current flowing therethrough to zero and thereafter to maintain the thyristor bridge in an electrically open condition preventing the alternating current from flowing therethrough for a predetermined period of time.

U.S. Pat. No. 5,694,279, “Superconductive fault-current limiters,” assigned to GEC Alsthom Limited (Great Britain), describes an inductive superconductive fault-current limiter that includes an iron core having a wound primary winding and a short-circuited superconductive secondary. The secondary remains superconductive up to a fault-current level in the primary, after which the superconductive secondary becomes resistive, the primary ampere-turns are not balanced, and the device becomes highly inductive, so limiting the fault-current. The fault-current threshold is increased without exceeding available critical superconductive current density levels and with a moderate superconductive coating thickness by using a stack of superconductive-coated washers having a large radial extent compared to the coating thickness.

U.S. Pat. No. 5,604,473, “Shaped superconducting magnetic coil,” assigned to American Superconductor Corporation (Westborough, Mass.), describes double coils including a pair of coils of different outer dimensions, which are wound from the same continuous length of superconducting wire. The double coils are coaxially positioned and electrically interconnected along a longitudinal axis to provide a multi-coil superconducting magnetic coil assembly. Each of the double pancakes has at least one of its coils electrically connected to at least another coil of an adjacent double coil having substantially the same outer dimension. The electrical connections between adjacent coils are provided with relatively straight or “unbent” segments of superconducting wire even though the outer dimension profile of the superconducting magnetic coil assembly along its longitudinal axis varies.

U.S. Pat. No. 5,600,522, “High temperature superconducting fault-current limiter,” assigned to ARCH Development Corporation (Chicago, Ill.), describes a fault-current limiter for an electrical circuit. The fault-current limiter includes a high temperature superconductor in the electrical circuit. The high temperature superconductor is cooled below its critical temperature to maintain the superconducting electrical properties during operation as the fault-current limiter.

U.S. Pat. No. 4,490,769, “Solid-state circuit breaker with current limiting characteristic using a superconducting coil,” assigned to The United States of America as represented by the United States (Washington, D.C.), describes a thyristor bridge interposing an AC source and a load. A series connected DC source and superconducting coil within the bridge biases the thyristors thereof so as to permit bidirectional AC current flow therethrough under normal operating conditions. Upon a fault condition a control circuit triggers the thyristors so as to reduce AC current flow therethrough to zero in less than two cycles and to open the bridge thereafter. Upon a temporary overload condition the control circuit triggers the thyristors so as to limit AC current flow therethrough to an acceptable level.

U.S. Pat. No. 4,470,090, “Superconducting induction apparatus,” assigned to Westinghouse Electric Corp. (Pittsburgh, Pa.), describes a winding for a superconducting inductive apparatus having one or more sets of main and auxiliary superconducting windings connected in parallel, with the auxiliary winding being disposed in a field-free region of the main winding. The main and auxiliary windings are arranged such that the main winding carries substantially all of the normal operating current of the apparatus and the auxiliary winding, which is located in a field-free region, carries overload currents of the apparatus. The volume of the main windings may thus be reduced, reducing the hysteresis and eddy current losses of the apparatus during normal operation, while incorporating a built-in safety factor to withstand excessive overloads.

### SUMMARY OF THE INVENTION

This invention solves the problems described in the preceding paragraphs by creating an inductor, for use in the bridge circuit 115 of FIG. 1, using two or more coils connected in parallel, with at least one coil superconducting and a least one coil of a conventional conductor such as copper or aluminum.

The coils are configured in such a way that the DC current bias 170 and any other DC components of current are carried mainly in the superconducting coils and AC current components are carried mainly in the coils made of conventional (e.g. copper or aluminum) conductor. The superconducting coil handles the DC current bias 170 to eliminate I²R losses. The conventional coil, which is easily made of transposed strands to handle AC and is not sensitive to temperature rises due to losses, handles the AC ripple during normal operation and AC currents during the short duration of the fault. Because the fault is of short duration (typically less than tenths of a second to several seconds) the conductor cross section can be small because the I²R losses only occur for a short time. In this way a relatively small, efficient, and compact overall inductive coil element (of parallel superconducting and conventional coils) is formed having relatively small losses at cryogenic temperatures with correspondingly low capital and operating refrigeration and cooling costs.

Furthermore, a magnetic field-shaping permeable magnetic material can be provided to reduce radial fields near the ends of the coils, thereby maximizing the critical current to which the superconductor can operate without losses and to further reduce AC losses on the superconductor. Finally, the various coils can be thermally isolated at separate optimal temperatures and separately cooled to improve overall performance and refrigeration efficiency.

In its most general form, the present invention is, in a bridge type of fault-current limiter application, any arrangement of coils of superconducting and normal materials which directs AC current components substantially into the normal coils and directs DC current components substantially into the superconducting coils. As a result, I²R and AC losses are reduced, refrigeration loads are minimized, efficiency is therefore improved, refrigeration capital cost reduced, and a relatively compact and space-efficient coil assembly can be made.

FIGS. 2, 3, and 4 illustrate an embodiment of the present invention. This is one of a plurality of embodiments of this invention, which are described by an approximate equivalent circuit illustrated in FIG. 5. The physics defining how AC current components are caused to flow through the normal coils and DC current components are caused to flow through the superconducting coils is described in reference to FIG. 5 hereinafter.

A magnetic field-shaping permeable magnetic material may be used with single-coil limiters such that the radial fields are reduced near the ends of the coil to maximize the critical current to which the superconductor can operate without I²R losses and to further reduce AC losses on the superconductor. Field shaping can be used or in combination with the coil arrangements described above for these reasons and to further maximize the coupling of magnetic fields produced by the various coils.

Finally, the various coils within the coil arrangement of the present invention may be thermally isolated at separate optimal temperatures and separately cooled to improve overall performance and refrigeration efficiency.

### BRIEF DESCRIPTION OF THE DRAWINGS

For better understanding of the invention, reference is had to the following description taken in connection with the accompanying drawings, in which:

FIG. 1 is a schematic diagram of the prior art Boenig bridge type of fault-current limiter in a power transmission system.

FIG. 2 is a partially sectioned perspective view of a two winding fault-current limiter in accordance with the invention;

FIG. 3 is a perspective view of the coil assembly of the two winding fault-current limiter of FIG. 2;

FIG. 4 is a cross-sectional view taken along the line 4-4 of FIG. 3 of the fault-current limiter;

FIG. 5 is an approximate equivalent circuit for a plurality of alternative embodiments in accordance with the invention for the inductors of a bridge-type fault current limiter; and

FIG. 6 is similar to FIG. 1 with the equivalent circuit of FIG. 5 replacing the current limiting inductor of FIG. 1.

### DESCRIPTION OF PREFERRED EMBODIMENTS

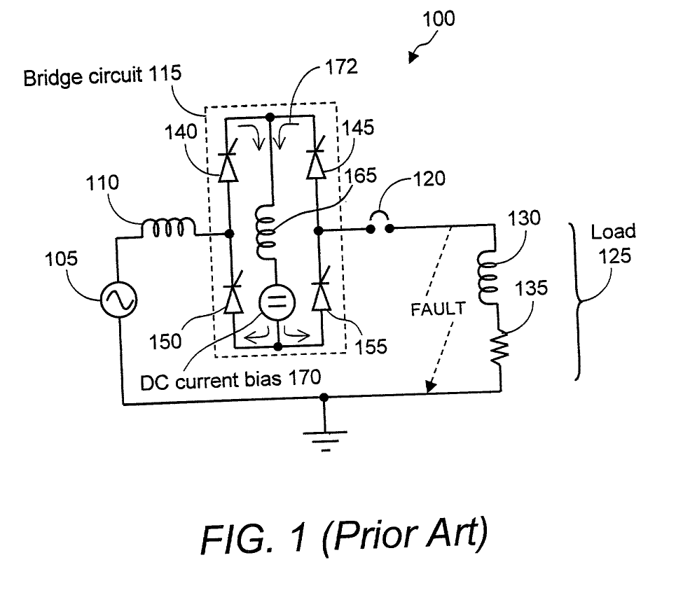

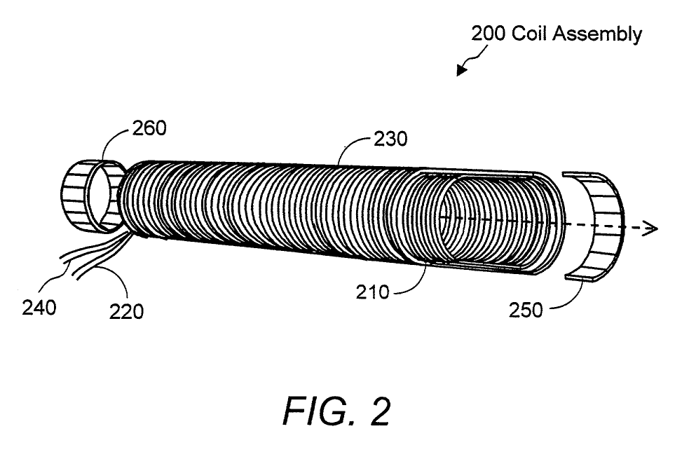

FIG. 2 is a perspective view of a two-winding fault-current limiter 200 with flux shaper and thermal isolation in accordance with the invention, for use in an electrical transmission/distribution application. More specifically, the coil assembly of the two-winding fault-current limiter 200 is suitable for use as the current limiting coil (i.e., the inductor 165) in the bridge type of fault-current limiter (i.e., the bridge circuit 115) as described in FIG. 1. These units have been favorably tested, one in each phase of a three-phase, 15 KV, 2000 to 4000 ampere, 54 MVA, bridge-type of fault current limiter.

The two-winding fault current limiter 200 includes a normal coil 210 having a first lead 220 and a second lead 220 (not shown) disposed at opposing ends. The normal coil 210 is disposed concentrically within a larger diameter superconducting coil 230 having approximately the same number of turns as the normal coil 210 and having a first lead 240 and a second lead 240 (not shown) disposed at opposing ends. The two-winding fault current limiter 200 further includes a flux shunt 250 (illustrated in section) disposed at one end of the two-winding fault current limiter 200, and a flux shunt 260 disposed at the opposing end of the two-winding fault current limiter 200. The flux shunts 250 and 260 are coaxially oriented in relation to the normal coil 210 and the superconducting coil 230 as shown in FIG. 2.

The fault-current limiter coil assembly of the present invention is not limited to the two-winding fault current limiter 200 arrangement illustrated in FIG. 2. The two-winding fault current limiter 200 is intended to show but one example of a parallel superconducting coil/normal coil arrangement. Alternatively, any arrangement of coils of superconducting and normal materials, which directs AC current components substantially into the normal coils and directs the DC current components substantially into the superconducting coils, falls within the scope of this invention.

In addition to the configuration of FIG. 2, an alternative configuration of this invention (not shown) has a superconductor ring coil overlapping and concentric with an axially longer but radially smaller normal coil. Both coils are overlapped by a concentric larger diameter normal coil. This embodiment is are described in the provisional application referenced above and hereby incorporated by reference. Another embodiment in the provisional application has the superconductor coil as a torroidal winding coaxial with an enclosed smaller diameter normal torroidal winding. These are certainly other coil configurations that will meet the broader description of this invention.

Likewise, the flux shunts 250 and 260 of the fault-current limiter coil assembly of the present invention are not limited to that illustrated in FIG. 2. For example, the flux shunts 250 and 260 can be connected around the outside of the coils of FIG. 2 with permeable material to form a return magnetic flux circuit. This return circuit can be cylindrically symmetrical and co-axial, and the shunts 250 and 260 can even be incorporated into a single shunt composed of radially and axially-running laminations (not shown) which extend from one end to the other of the coil set.

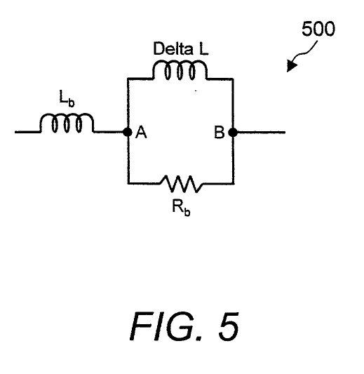

The two-winding fault current limiter 200 greatly reduces AC losses (that would otherwise result) by using the normal coil 210, disposed within and electrically connected in parallel to, the larger superconducting coil 230. The AC fault current and AC ripple current components tend to flow through the normal coil 210, which can be designed for lower ac losses, and the DC bias and DC fault current components tend to flow through the superconducting coil 230, substantially eliminating I²R losses. Details of operation will be further described in reference to FIG. 5 below.

A portion of FIG. 2 shows a “cutaway” view of the two-winding fault current limiter 200, where the normal coil 210 is shown disposed within the larger superconducting coil 230 and properly oriented to the magnetic flux shunts 250 and 260. The windings of the normal coil 210 and the superconducting coil 230 are shown as having a “single-spiral, layer wind” geometry in which each coil has a helically wound length of material. For the normal coil 210, this helix is made from a single Rutherford cable (of multiple insulated transposed copper strands) wound on edge. For the superconducting coil 230, the helix has a radial stack of HTS tapes wound one on top of the other in a single helical groove from one end of the coil to the other. Alternatively, a “pancake-wound” geometry or a multiple layer-wind geometry are acceptable. These constructions are well known to those skilled in the art of winding coils.

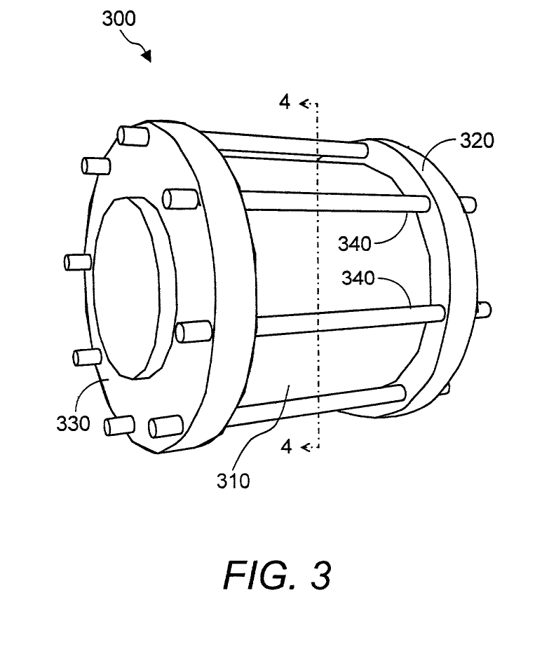

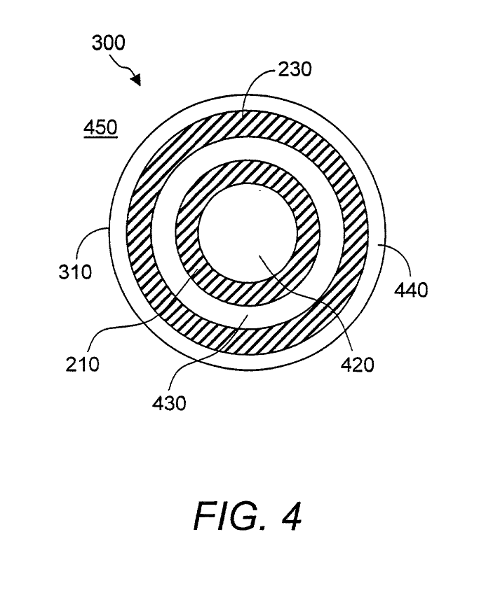

The normal coil 210 and the superconducting coil 230 are cylindrical and co-axial, but with differing overall diameters. In the example of FIG. 2, the normal coil 210 and the superconducting coil 230 are assembled such that they are thermally and mechanically isolated from one another, as described with reference to FIGS. 3 and 4 below. Electrically, however, the normal coil 210 and the superconducting coil 230 are connected in parallel, as each of the leads 220 and 240 on each corresponding end of the two-winding fault current limiter 200 are electrically connected.

The normal coil 210 is formed of an epoxy-impregnated winding of copper or other metals or alloys and, in the example of FIG. 2, is maintained in a vacuum during normal operation (no fault) of the fault-current limiter at a temperature approximately that of the superconducting coil 230. In principle, however, the normal coil 210 can be operated at any temperature that is convenient, so long as a thermal isolation, such as vacuum, and HTS leads or some other mechanism are provided to limit thermal conduction, convection, and radiation of heat from the normal coil 210 to the superconducting coil 230.

The superconducting coil 230, in the example of FIG. 2, is an epoxy-impregnated coil wound of high-temperature superconducting (HTS) material, such as bismuth-strontium-calcium-copper-oxide (BSCCO) or yttrium-barium-copper-oxide (YBCO), and is maintained in a vacuum at a typical temperature of 40° K. Alternatively, the superconducting coil 230 may be wound of low-temperature superconducting (LTS) material, such as twisted and transposed strands of multifilamentary niobium-titanium alloy in a relatively resistive normal metal or alloy matrix. The coil may be impregnated with epoxy-resin and maintained in a vacuum at a typical temperature of 4° K. However, in a preferred embodiment, the superconducting coil 230 is wound of HTS material. The choice of operating temperature depends on many factors and in principle can be at any temperature up to the critical temperature of the superconductor material used for the superconducting coil 230, the preference being to use that economically available superconductor having the highest critical temperature and highest critical current at some practical temperature of operation below its critical temperature.

The flux shunts 250 and 260 are formed of a permeable ferromagnetic material, preferably laminated for low AC loss. For the two-winding fault current limiter 200 coil set, the laminates of oriented iron run out both axially and radially, and each laminate is typically 10 to 20 mils thick. In operation, the flux shunts 250 and 260 perform to shunt the flux axially away from the end turn region of the superconducting coil 230 of the two-winding fault current limiter 200 coil set, such that the mutual flux of the normal coil 210 and the superconducting coil 230 is increased, and/or the radial component of the magnetic field is reduced so that the critical current of the superconductor is increased, and/or AC losses in the superconducting coil 230 may be reduced. Alternatively, more superconducting material may be used in the end turn region of the superconducting coil 230 to maintain the current carrying capacity.

In the example of FIG. 2, only small AC ripple fields are present so that AC losses in the flux shunts 250 and 260 are low and the flux shunts 250 and 260 can be thermally connected to the normal coil 210 and the superconducting coil 230. In principle, however, the flux shunts 250 and 260 can be maintained at any temperature that seems practical, so long as a mechanism for removal of AC losses is provided and vacuum or some other form of thermal insulation is provided to limit the transfer of heat from the shunts into the superconducting coil 230.

FIG. 3 is a perspective view of a coil assembly 300 for two-winding fault current limiter 200 in accordance with the invention. Housed in fault-current limiter coil assembly 300 is the normal coil 210 and the superconducting coil 230, each coil epoxy-impregnated with its co-wound cooling tube as a separate unit, and arranged between an end plate assembly 320 and an end plate assembly 330, all of which are mechanically secured with a plurality of tie-rods 340 extending the length of fault current limiter coil assembly 300, bolting together end plate assembly 320 and end plate assembly 330 with the coils and shroud in between, as shown in FIG. 3. Visible in this view of the fault current limiter coil assembly 300 is a shroud 310 surrounding the normal coil 210 and the superconducting coil 230.

FIG. 4 (not drawn to scale) is a cross-sectional view of the fault current limiter coil assembly 300, in accordance with the invention, taken along line 4-4 of FIG. 3. FIG. 4 shows the normal coil 210 disposed concentrically within the larger superconducting coil 230. Additionally, FIG. 4 shows a vacuum region 420 in the center region of the normal coil 210, a vacuum region 430 between the outer perimeter of the normal coil 210 and the inner perimeter of the superconducting coil 230, a vacuum region 440 outside of the outer perimeter of the superconducting coil 230 and inside of the fiberglass epoxy, (for example), insulating shroud 310, and a vacuum region 450 outside of the perimeter of the shroud 310. Optionally, a thermal and/or radiation shield (not shown) may be present in the vacuum region 430 between the outer perimeter of the normal coil 210 and the inner perimeter of the superconducting coil 230. However, if the superconducting coil 230 and the normal coil 210 are sufficiently close in temperature such a shield is not needed. In FIG. 4 the latter case is assumed and the vacuum region 430 by itself provides thermal isolation between the normal coil 210 and the superconducting coil 230.

It should be noted that all of the enclosures, devices and entry/exit ports associated with providing vacuum and thermal control to the two-winding fault current limiter 200 coil set, are not shown, for the sake of clarity, in FIGS. 3 and 4. These are not novel features of the present invention.

With continuing reference to FIGS. 2, 3 and 4, an example is provided of electrical and physical specifications of the two-winding fault current limiter 200 appropriate for use in a bridge type of fault-current limiter as described in FIG. 1 (i.e., limiter 200 replaces the inductor 165 of the bridge circuit 115). (Other examples could be provided).

The normal coil 210: Formed using a single well-known Rutherford cable (i.e. a cable with 8 transposed strands of insulated copper wires cabled together to make an overall conductor of rectangular cross section, in this case approximately 9.6 mm high by 3.9 mm wide), approximately 180 m in length, wound on edge in a single spiral winding groove having 90 turns and a winding pitch of 6.4 millimeters on a conventional cylindrical G-10 epoxy-fiberglass winding form that is approximately 640 mm I.D. by 660 mm O.D. by 540 mm long. The spiral winding groove is created by inserting approximately 0.75 mm thick G-10 radially slit annular spacer/insulator discs into a shallow (approximately 1.5 mm wide) spiral groove in the former so that the discs overlap, creating collectively a 540 mm long “slinky” with a 180 m path length anchored axially in the spiral groove in the former. A cooling tube that circulates pressurized gaseous helium is wound in the same groove as the cable; together the coil cable, cooling tube and the spiral of G-10 slit discs are epoxy impregnated onto the G-10 winding form.

The superconducting coil 230: Formed using approximately 100 superconducting tapes each having a length of approximately 210 m, a typical thickness of 0.25 mm, and a typical width of 3.8 mm. The 100 superconducting tapes are wound one on top of the other in a single spiral groove having 95 turns and a winding pitch of 6.4 millimeters on a conventional cylindrical G-10 epoxy-fiberglass winding form that is approximately 704 mm I.D. by 720 mm O.D. by 605 mm long. The spiral winding groove is created by inserting approximately 0.75 mm thick G-10 radially slit annular spacer/insulator discs into a shallow approximately 1.5 mm wide spiral groove in the former so that the discs overlap, creating collectively a 605 mm long “slinky” with a path length of 210 m anchored axially in the groove in the former. A cooling tube that circulates pressurized gaseous helium is placed in the same groove as the superconducting tapes; together the tapes, cooling tube and the spiral of G-10 slit discs are epoxy impregnated onto the G-10 winding form.

The normal coil 210 is nested within the superconducting coil 230, where the positional relationship between the normal coil 210 and the superconducting coil 230 is maintained by the end plate assemblies 320 and 330 of the fault current limiter coil assembly 300.

Rutherford cable is exemplary of low AC loss winding configuration. Litz wire is another example.

Example specifications for the two-winding fault current limiter 200: voltage rating=15 kV, current rating=2000 A to 4000 A, power rating=54 MVA.

Example specifications for the fault current limiter coil assembly 300: length approximately 755 mm, diameter approximately 1000 mm, L_{b}=4 mH. (FIG. 5)

Example specifications for the normal coil 210: axial length approximately 540 mm, diameter approximately 610 mm, R_{b}=0.005 ohms. (FIG. 5)

Example specifications for the superconducting coil 230: axial length approximately 605 mm, diameter approximately 0.75 m, Delta L=0.6 mH. (FIG. 5)

The spacing between the outer perimeter of the normal coil 210 and the inner perimeter of the superconducting coil 230 is, for example, 44 mm.

It should be noted that the above specifications are for one example of the present invention, i.e., the two-winding fault current limiter 200 coil set. This invention is not limited to this one example. For instance, it may be desirable to scale the two-winding fault current limiter 200 to higher voltage ratings, such as 69 kV, 115 kV, or 345 kV at similar current ratings, or an alternative coil arrangement can be utilized. Therefore, the physical attributes are adjusted accordingly.

FIG. 5 is a schematic drawing of an equivalent circuit 500 that describes a set of approaches for this invention that includes the two-winding fault current limiter 200 coil set of FIG. 2 in accordance with the invention. The physics of operation of this invention to cause AC currents to flow primarily in normal coils and to cause DC currents to flow primarily in superconducting coils is described here with respect to FIG. 5 and the two-winding fault current limiter 200 coil set shown in FIG. 2. It is the presence of the normal coil 210 electrically connected in parallel with the superconducting coil 230 in combination with the physical relationship (i.e., the normal coil 210 disposed concentrically within the larger superconducting coil 230) that enables the novel operation of the two-winding fault current limiter 200 coil set.

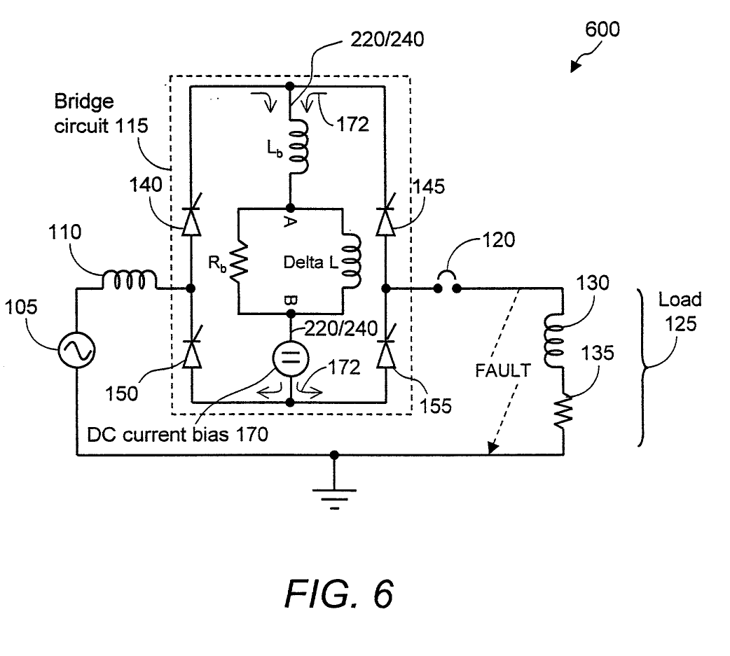

The equivalent circuit 500 is considered as replacing the inductor 165 of the AC circuit 100 of FIG. 1 (as shown in FIG. 6).

The equivalent circuit 500 includes an equivalent common coil inductance L_{b} electrically connected to a node A, a normal coil resistance R_{b} electrically connected between node A and a node B, and an equivalent additional inductance for the superconducting coil Delta L (as explained more fully hereinafter) electrically connected in parallel to R_{b} between nodes A and B.

L_{b} represents fields and field energy in the inside of the normal coil 210 and also the field and field energy external to the superconducting coil 230 that result from current that flows either through the normal coil 210 or the superconducting coil 230 or through a combination of both coils. Because of the concentric arrangement of the superconducting coil 230 and the normal coil 210, their closeness, and the nearly matched number of turns in each, this common field and the common field energy are essentially the same, regardless of which coil the current flows through. As a consequence, the ratio of current that flows through the superconducting coil 230 and the normal coil 210 depends approximately inversely on the ratio of the additional impedances separately affecting the superconducting coil 230 and the normal coil 210, even though the main impedance limiting the AC current is associated with L_{b}.

Delta L represents the field and field energy in the region between the normal coil 210 and the superconducting coil 230 that is created by current flowing in the superconducting coil 230. The impedances offered by inductances L_{b} and Delta L are proportional to the AC frequency times these inductances. Thus for DC current components, such as the main part of the DC bias current, where the frequency is zero, the impedances of L_{b} and Delta L are zero and current flows through the superconducting coil 230 which has no impedance and no I²R losses compared to the resistive impedance R_{b} of the normal coil 210. However, for a 100 Hz or 120 Hz AC current, components which represent the fundamental frequency of bias ripple and fault current components (from full wave rectification of 50 or 60 Hz AC), the impedance 2π×frequency×Delta L is large compared to R_{b}, and the AC current through the two-coil inductor 165 thus flows mainly through the normal coil 210, avoiding the higher AC losses that would otherwise be produced in the superconducting coil 230 [as compared to lower AC eddy current and short term I²R losses produced in the normal coil which can be accepted at higher temperatures at lower refrigeration cost]. (The principles of the present invention are not limited to the 50 and 60 Hz values mentioned above.)

In order to better define the novel operation of the present invention, a brief discussion of possible current limiting coils (used in a bridge type of fault current limiter application) is included below.

During normal operation (no fault present), there is a fixed large DC bias current component (2000 to 4000 A) that flows continuously through the inductor assembly 210/230, as described in reference to FIG. 1. For a copper or other conventional metal coil (inductor) alone this current would produce substantial (Joule heating) I²R losses continuously. Removing this heat typically requires cooling oil, pumps, heat exchangers and fans. The I²R losses and power to run the fans and pumps is power that cannot be delivered to the customer and would therefore be lost energy adding to the inefficiency of the transmission/distribution system.

The fault current limiter also generates a continuous AC ripple current component on top of the DC bias current. This ripple produces AC fields and AC losses in the coil assembly 210/230, but these would tend to be small compared to the I²R losses. The I²R losses can be made small enough to be more tolerated in a copper or other normal metal coil near ambient temperature if there is a large enough cross-section of copper to substantially reduce R and if the conductor is made of transposed insulated strands smaller in diameter than a skin depth. Even so, this construction would require a large quantity of copper, a larger overall coil and increased cost on both counts.

In the case FIG. 1 of a superconducting current limiting coil alone, there is no resistance to the DC main component of the bias current and consequently no I²R losses. However, the AC ripple current component of the bias current creates an AC field that does produce superconducting hysteresis and eddy current AC losses as heat generation. Since a superconductor must be operated at low temperatures and requires cryogenic cooling, every watt of I²R loss is at the expense of 20-1000 watts of compressor power. As a result, there is a substantial refrigeration cost penalty when using superconducting current limiting coils alone. There is a much larger AC ripple current component superposed on a DC current increase that occurs during fault, but this AC current and associated losses occur for only a short time (typically less than one second). Thus, while this fault AC loss heating may be large, it is not continual. Even so, care must be taken to insure that the temperature of the superconductor doesn't rise excessively, reducing its critical current, and extra refrigeration is needed to insure that the heat generated during fault is removed.

AC hysteresis and eddy current losses can be reduced by using coils made with cables or braids of twisted, insulated and transposed superconductor strands made of fine filaments of superconductor embedded in a resistive metal or alloy matrix. This has been done with coils produced of fine-stranded low temperature superconductor (LTS) wire, however, refrigeration at the temperatures required for LTS (˜4K) is very costly, approaching the 1000 Watts per Watt of AC loss removed. The use of high-temperature superconductor (HTS) coils would tend to decrease the cost of refrigeration because of the lower refrigeration power needed (about 100 Watts per Watt of heat generated) at the higher temperature at which the heat is extracted (40 K vs. 4 K). Unfortunately, at this time low loss configurations of HTS superconductors have not been developed and HTS coils experience higher AC losses, which tend to offset the lower cost per Watt for refrigeration.

These problems are solved by use of the present invention, which, in its most general form, is any arrangement of coils of superconducting and normal materials which achieves a division of AC current components substantially into the normal coils and DC current components substantially into the superconducting coils. Circuit 500, as stated, is the approximate equivalent circuit describing constructions which realize this division of currents, as described earlier. The physical connection of the example two-winding fault current limiter 200 to the equivalent circuit elements of the equivalent circuit 500 is further described as follows.

In the case of the two-winding fault current limiter 200 having the normal coil 210 electrically connected in parallel with the superconducting coil 230, and with continuing reference to FIGS. 4 and 5, there is a DC and/or AC magnetic field component along the axis of the two-winding fault current limiter 200 regardless of whether the current that flows travels through the normal coil 210 or the superconducting coil 230. This component is due to the concentric arrangement of the normal coil 210 within the superconducting coil 230. The magnetic field energy associated with this field throughout the vacuum region 420 in the center region of the normal coil 210 and the field external to both coils is produced either by current flow through the normal coil 210 or the superconducting coil 230 or both, and is responsible for the common inductance L_{b} of FIG. 5.

All of the energy of the magnetic field of the normal coil 210 is already included in the calculation of inductance L_{b}. The normal coil 210 has a resistive winding, represented by resistance R_{b} of FIG. 5.

There is no resistance in the superconducting coil 230. However, there is an inductance resulting from the magnetic field and the magnetic field energy of the superconducting coil 230 in the vacuum region 430 between the outer perimeter of the normal coil 210 and the inner perimeter of the superconducting coil 230. This inductance is represented by Delta L of FIG. 5.

Following is a Summary of Impedance elements of the two-winding fault current limiter 200 with respect to the equivalent circuit 500, based on the physical parameters of the coils as presented in the example above.

Inductance L_{b}=approximately 4 mH=coil set common inductance primarily due to the energy of the magnetic field in the vacuum region 420 of the normal coil 210 and in the region external to the superconducting coil 230. The impedance of L_{b}=[(2π×frequency×L_{b})=zero for DC and approximately 3 Ohms for ac ripple or fault current components at 120 Hz.

Resistance R_{b}=approximately 0.005 Ohms=winding resistance of the normal coil 210, DC or AC for a cable of insulated strands that are small compared to the skin depth.

Inductance Delta L=approximately 0.6 mH=inductance primarily due to the energy of the magnetic field in the vacuum region 430 resulting only from the magnetic field of the superconducting coil 230. The impedance of Delta L=(2π×frequency×Delta L)=zero for DC and approximately 0.4 Ohms for ac ripple or fault current components at 120 Hz.

The ratio of (current through the normal coil 210)/(current through the superconducting coil 230) for ac ripple or fault current components at 120 Hz=(2π×frequency×Delta L)/R_{b}=approximately (0.4 Ohms)/(0.005 Ohms)=approximately 80.

Total AC coil set impedance @120 Hz (current is flowing mainly through the normal coil 210)=approximately [(2π×frequency×L_{b})+R_{b}]=approximately 3 Ohms+0.005 Ohms=approximately 3.005 Ohms.

Total DC impedance @zero Hz (current is flowing mainly through the Superconducting coil 230)=approximately [(2π×frequency×L_{b})+(2π×frequency×Delta L)]=approximately zero+zero=approximately zero.

Discussion of the DC bias current in normal operation when there is no fault current present follows, with continuing reference to FIGS. 4 and 5. In this case the DC bias current (supplied by the DC voltage bias supply 170 of FIG. 1) flows entirely through the superconducting coil 230, which has essentially no resistance and zero impedance at zero frequency. There is no voltage drop across the superconducting coil 230, no DC losses, and no I²R losses.

Secondly, discussion of the AC ripple current in normal operation when there is no fault current present follows. In this case the AC ripple current is mainly limited by the inductive impedance associated with L_{b} that is calculated as 2π×frequency×inductance L_{b}. The AC ripple current at node A of FIG. 5 must flow either through the superconducting coil 230 (having inductance Delta L) or the normal coil 210 (having resistance R_{b}). The inductive impedance associated with Delta L (which represents the magnetic field and field energy in the space between the normal coil 210 and the superconducting coil 230 created by the current of the superconducting coil 230 is calculated as 2π×frequency×inductance Delta L. As described previously R_{b} is the resistance of the copper winding of the normal coil 210. The superconducting coil 230 is designed such that inductive impedance of Delta L (at the 120 Hz fundamental frequency of the AC component of the full wave rectified 60 Hz AC that forms the bias current) is much larger than resistance R_{b} of the normal coil 210. This is accomplished by providing a sufficient stranded and transposed conductor cross section in (copper) the normal coil 210 so that it has relatively low resistance, R_{b}, and by providing sufficient magnetic field magnitude (by having sufficiently high number of superconducting turns per unit length) and sufficient volume for the magnetic field (by making the outer superconducting coil 230 sufficiently larger than the resistive inner normal coil 210). Because the AC ripple field is present mainly only in the vacuum region 420 of the normal coil 210, returning mainly external to both coils, the superconducting coil 230 is mainly not exposed to the AC field, and AC losses in the superconductor winding are small.

To summarize the normal operation of the two-winding fault current limiter 200 coil set: DC losses are essentially zero and AC losses occur almost entirely in the normal coil 210 with very little AC losses incurred in the superconducting coil 230. Thus there are essentially no DC or AC refrigeration losses in the superconducting coil 230. Since the normal coil 210 can be designed to operate at room temperature, the AC losses in the normal coil 210 do not need to be removed by low temperature refrigeration. Alternatively, the normal coil 210 can operate at any convenient temperature of choice, minimizing refrigeration cost for the system overall.

Discussion of the operation of the two-winding fault current limiter 200 when a fault occurs follows, with continuing reference to FIGS. 4 and 5. As in normal operation, the AC fault current is limited primarily by the inductive impedance associated with L_{b}. As for normal operation, the impedance of Delta L at the fundamental 120 Hz AC bridge component of the fault is much larger than resistance R_{b} of the normal coil 210. The 120 Hz fundamental AC component of the rectified fault current flows almost entirely through the normal coil 210 of resistance R_{b}. Nor is the superconducting coil 230 exposed to any appreciable AC fault current or AC field during fault. There are, therefore, no appreciable AC losses in the superconducting coil 230 and the increase in DC current is relatively slow, so that there are no appreciable refrigeration loads associated with the superconducting coil.

Typically, a fault lasts from less than 0.1 seconds to several seconds. For example, a short circuit to ground on the line may cause large AC currents to flow, which currents are controlled by the current limiter of the present invention.

To summarize, with the 100 or 120 Hz full wave rectified AC of the fault, AC current flows mainly through the normal coil 210. The normal coil 210 does incur substantial losses due to the large fault current, but the fault-current condition is only present for a relatively short time (typically less than one second); producing a total temperature rise in the normal coil in the range of 10 to 60 C. The rise in temperature does not present any particular problem, as the normal coil 210 can sustain a temperature increase from normal temperature to the elevated temperature with no serious consequences. In fact, the duration of the fault may be so short that the normal coil 210 does not heat up enough to require additional cooling.

By contrast, with a superconducting current limiting coil alone as in a FIG. 1 circuit, for example, the superconducting coil would carry an appreciable AC ripple refrigeration load during normal operation and would have heated up additionally during the fault condition. More refrigeration would be needed, and sufficient refrigeration costs can prohibit using a superconducting current limiting coil at all. Secondly, if the temperature of the superconducting coil rises substantially it will not be able to carry the required DC bias current and some period of time would be needed while the superconducting coil is cooled and returned to the superconducting state before the main circuit breaker 120 (FIG. 1) is re-closed. This added re-close time may not be tolerated for utility system operation. In summary, the example of the two-winding fault current limiter 200 coil set, having the normal coil 210 electrically connected in parallel with the superconducting coil 230 and having the normal coil 210 disposed concentrically within the larger superconducting coil 230, essentially eliminates the large AC losses that would be found in a bridge type of fault current limiter having a superconducting coil alone and minimizes heat generation due mainly to DC I²R losses that would be found in a normal coil alone. This results from the DC bias current being caused to flow primarily through the superconducting coil 230 with essentially no impedances and essentially no losses. AC current, either the AC ripple current or the fault current, tends to be limited mainly by inductance L_{b} and flow through resistance R_{b}, because the inductive impedance of Delta L is large compared to R_{b} at the 120 Hz fundamental frequency of the full wave rectified bias or fault current. Finally, the example two-winding fault current limiter 200 coil set of the present invention provides efficient operation and insures that superconducting coil 230 remains superconducting through the fault.

What is claimed:

1. A fault current limiter of the bridge type used in a line of an AC power transmission and/or distribution system, said fault current limiter of the bridge type being a bridge circuit having four legs and a bridge, each leg including a power semiconductor device, said bridge comprising:
a first path;
a second path connected in parallel to said first path, said second path having a substantially higher resistance to DC than said first path, said first path having a substantially higher impedance to AC than said second path,
a DC component of a fault current in said line flowing through said first path and an AC component of said fault current flowing through said second path.

2. A fault current limiter as in claim 1, wherein said first path includes a first inductive coil and said second path includes a second inductive coil.

3. A fault current limiter as in claim 2, wherein said first inductive coil is a coil of superconductive material substantially without resistance in operation and with inductive impedance, and said second inductive coil is a coil of conventional material with inductance and inherent resistance.

4. A fault current limiter as in claim 3, wherein an equivalent circuit of said inductive coils in parallel includes the inductance of said conventional material second coil in series with a parallel arrangement of said resistance of said conventional material second coil and an equivalent inductance that results from the physical positioning of said first inductive coil relative to said second inductive coil.

5. A fault current limiter as in claim 3, wherein said superconducting first coil has a linear axis and surrounds and is coaxial with said conventional material second coil said conventional material second coil being substantially within said first coil.

6. A fault current limiter as in claim 3, wherein said superconducting first coil has a circular axis and surrounds and is concentric with said conventional material second coil, said second coil being substantially within said first coil to provide a torroidal-shaped coil assembly.

7. A fault current limiter as in claim 5, wherein said two concentric coils have a first longitudinal end and a second longitudinal end, and further comprising a flux shunt at at least one of said first end and said second end to orient a magnetic flux field of said coils, said flux shunt at least one of enhancing performance of said first coil and reducing AC losses in said first coil.

8. A fault current limiter as in claim 7 wherein said flux shunt includes a permeable ferromagnetic material.

9. A fault current limiter as in claim 8 wherein said ferromagnetic material is laminated.

10. A fault current limiter as in claim 5, wherein a center region inside said second inductive coil is hollow and evacuated.

11. A fault current limiter as in claim 5, wherein an annular cylindrical space between said first and second coils is evacuated.

12. A fault current limiter as in claim 5, wherein an insulating shroud encloses said assembled inductive coils.

13. A fault current limiter as in claim 5, wherein a space between said shroud and said first inductive coil is evacuated.

14. A fault current limiter as in claim 13, wherein said shroud is enclosed in an evacuated space.

15. A fault current limiter as in claim 9, wherein a center region inside said second inductive coil is hollow and evacuated.

16. A fault current limiter as in claim 9, wherein an annular cylindrical space between said first and second coils is evacuated.

17. A fault current limiter as in claim 9, wherein an insulating shroud encloses said assembly of said inductive coils.

18. A fault current limiter as in claim 17, wherein a space between said shroud and said first inductive coil is evacuated.

19. A fault current limiter as in claim 18, wherein said shroud is enclosed in an evacuated space.

20. A fault current limiter as in claim 3, wherein said second coil is at a higher temperature than said first coil.
